(19) United States
(12) Patent Application Publication
(10) Pub. No.: US 2012/0117905 A1
(43) Pub. Date: May 17, 2012

(54) BRICK PRODUCT AND FABRICATING METHOD OF THE SAME

(75) Inventors: Chun-Lung Wang, Nantou County (TW); Pei-Tse Chen, Nantou County (TW)

(73) Assignee: National Taiwan Craft Research and Development Institute, Nantou County (TW)

(21) Appl. No.: 12/946,462

(22) Filed: Nov. 15, 2010

(51) Int. Cl. E04C 2/28; B32B 37/00

(52) U.S. Cl. 52/309.13; 156/154

(57) ABSTRACT

A brick product includes multiple brick segments respectively bonded to one another via an adhesive agent and a blind hole defined in a body of the respectively bonded brick segments such that the brick product is capable of receiving objects and functions in a way different from the conventional one.

### FIELD OF THE INVENTION

The present invention relates generally to a brick product, and more particularly to a brick product composed of multiple brick segments respectively and securely connected to one another via an adhesive agent and a blind hole defined in a body of the mutually connected brick segments. The fabricating method of the brick product includes the steps of preparing an adhesive agent, forming a durable base by applying the adhesive agent to adjacent bricks, cutting the durable base into a desired shape, and polishing the cut base.

### BACKGROUND OF THE INVENTION

As known in the art, cement is a well known adhesive agent in construction technology. In general, cement used in construction is characterized as hydraulic or non-hydraulic. Hydraulic cements (e.g., Portland cement) harden because of hydration chemical reactions that occur independently of the mixture's water content; they can harden even underwater or when constantly exposed to wet weather. The chemical reaction that results when the anhydrous cement powder is mixed with water produces hydrates that are not water-soluble. Non-hydraulic cements (e.g., lime and gypsum plaster) must be kept dry in order to retain their strength. Fabrication of cement is generally divided into preparation of raw material, calcining and finishing steps. In the step of raw material preparation, materials such as lime and clay are grinded into fine powder and well mixed. Thereafter, the fine mixture of clay and lime is put into a furnace for heating. Lastly, additives such as calcium sulfate and other suitable material is added to finish the formation of cement.

Normally, bricks are applied as the foundation of a construction. To improve the durability of the construction, cement is used as an adhesive agent between two adjacent bricks which are stacked on top of one another alternatively or other suitable ways so that the construction may be extended to a length (width or height) needed.

Bricks can be classified into stone brick, clay brick and red brick, three categories. The stone brick is the earliest construction element known and used by mankind, whereas a proper stone is selected and cut into the desired shape for building a construction. The clay brick is made of clay and is placed in shadow for drying out the water in the clay after the clay is shaped into a certain shape. And the red brick is calcining the clay of a certain shape. As the iron in the clay, after the calcining step, the finished brick is red and that is the reason it is called red brick.

Currently, the red brick is the most and widely used construction element in modern buildings and when it is applied, the sole purpose of the red brick is to reinforce the durability of the construction. There is no other requirement such as appearance to the appearance of the red brick such that the available red brick on the market is porous and has pretty rough surfaces. As a result of this, a cement coating is applied to the final construction made of red brick.

Fair bricks are then introduced to the market to mitigate the appearance problem that the red brick has. The fair brick is fabricated in a fully automated environment and is not affected by weather conditions. Therefore, the fair brick has better quality, yield and appearance. However, no matter what kind of application the brick is employed, the bricks are all used in construction of a certain structure. The application of the bricks is limited.

### SUMMARY OF THE INVENTION

To address these and other objects and in view of its purposes, the present invention provides a brick product composed of multiple brick segments mutually combined with one another with an adhesive agent. The brick product made in accordance with one embodiment of the present invention has at least one blind hole defined therein for receiving therein an object, e.g. dirt, such that a potential user of the brick product may use this brick product as a vast.

In accordance with another objective of the present invention, the method for fabricating the brick product includes the steps of preparing an adhesive agent, forming a durable base by applying the adhesive agent to adjacent bricks, cutting the durable base into a desired shape, and polishing the cut base.

In accordance with still another objective of the present invention, the method may also include a step of coating a waterproof agent on surfaces of the finished product to improve water resistance capability of the brick product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of the brick product of the present invention;

FIG. 2 is a cross sectional view of the brick product of the present invention shown in FIG. 1;

FIG. 3 is a flow chart showing the steps of making the brick product of the present invention;

FIG. 4 is a perspective view showing the base product of the brick product of the present invention;

FIG. 5 is a schematic view showing the initial cutting step is employed to the base product shown in FIG. 4;

FIG. 6 is a schematic view showing the formation of the blind hole;

FIG. 7 is a schematic view showing the application of a grinding machine to grind surfaces of the unfinished brick product;

FIG. 8 is a schematic view showing the application of a finishing machine to finely polish the surfaces of the semi-finished product; and

FIG. 9 is a schematic view showing the coating of a waterproof agent on the surfaces of the finished product.

It should be noted that all the Figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION OF THE PRESENT INVENTION

In the following description, numerous specific details are given to provide a thorough understanding of the invention. However, it will be apparent to one skilled in the art that the invention may be practiced without these specific details. In order to avoid obscuring the present invention, some well-known system configurations and process steps are not disclosed in detail.

Likewise, the drawings showing embodiments of the apparatus are semi-diagrammatic and not to scale and, particularly, some of the dimensions are for the clarity of presentation and are shown exaggerated in the figures. Also, where multiple embodiments are disclosed and described having some features in common, for clarity and ease of illustration and description thereof, like or similar features one to another will ordinarily be described with like reference numerals.

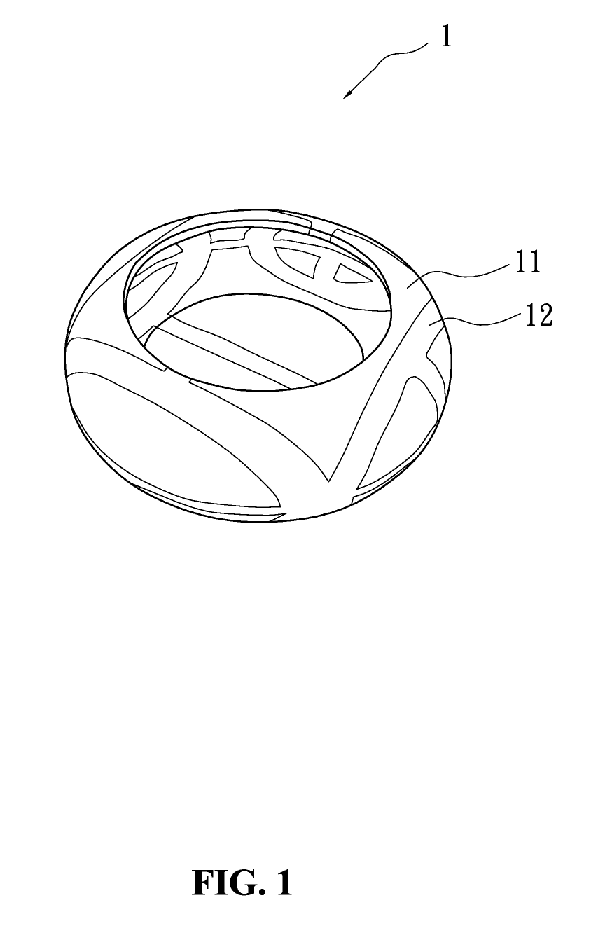

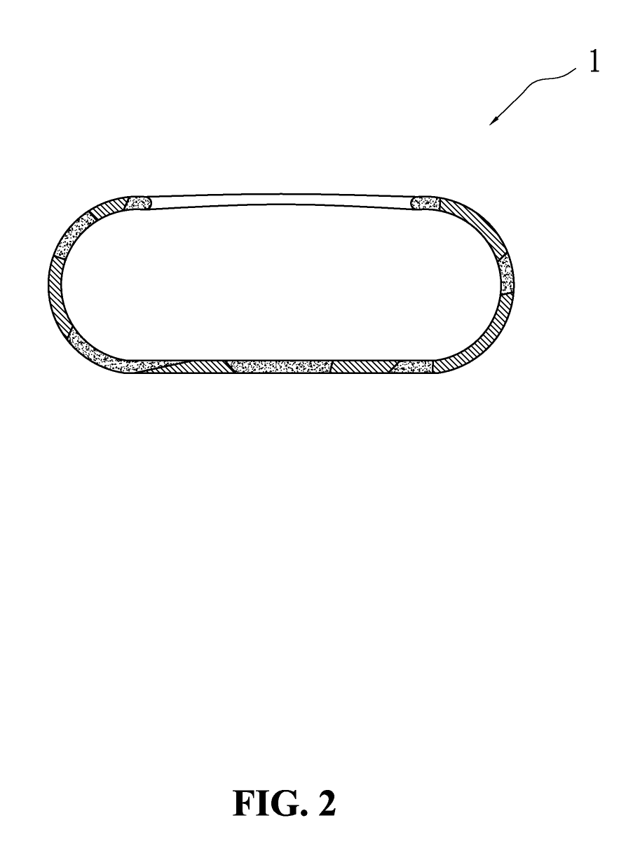

With reference to FIGS. 1 and 2, it is to be noted that the brick product 1 constructed in accordance with one embodiment of the present invention is consisted of multiple brick segments 11 mutually securely combined with an adhesive agent 12, preferably consisting of silica sand, cement and polymer clay benefits, each combined with one another with an appropriate proportion, e.g. 1:1:1. Preferably, the brick segments 11 are made via the method for the fair bricks as described earlier. The reason for the brick segments 11 to be the fair brick is that the fair brick has higher appearance, yield and stable output. Furthermore, a waterproof agent (not shown in the drawings specified) can be applied to outer surfaces of the brick product 1 to increase water resistance capability of the brick product 1 of the present invention.

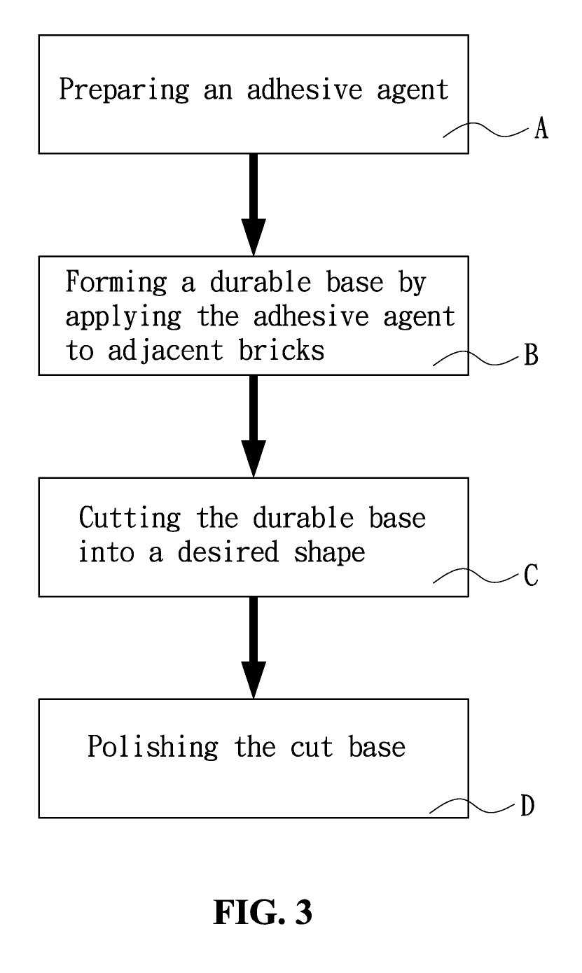

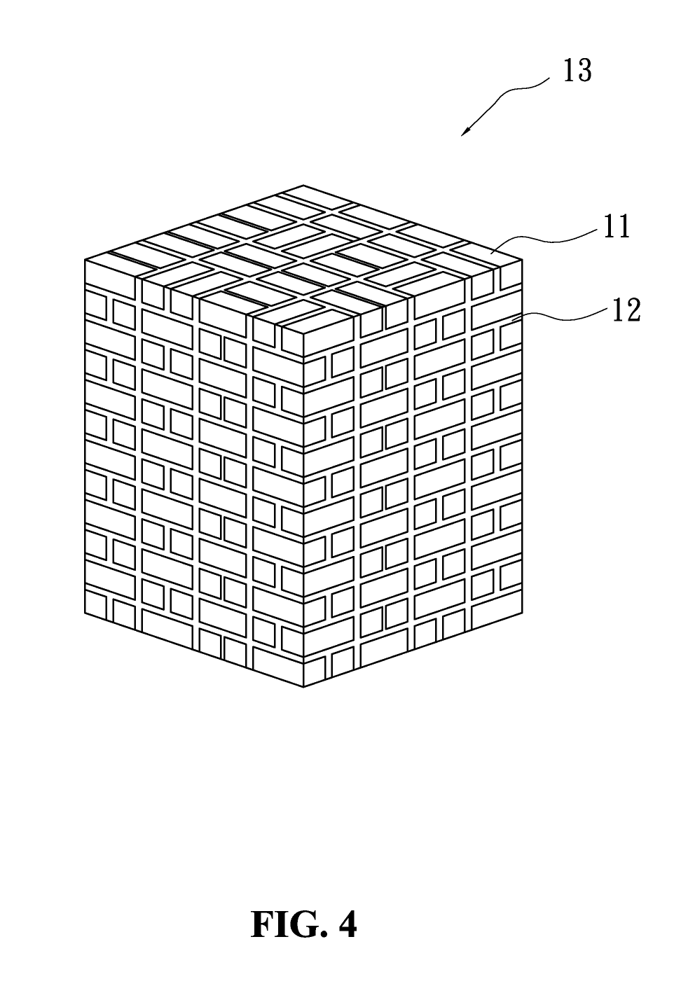

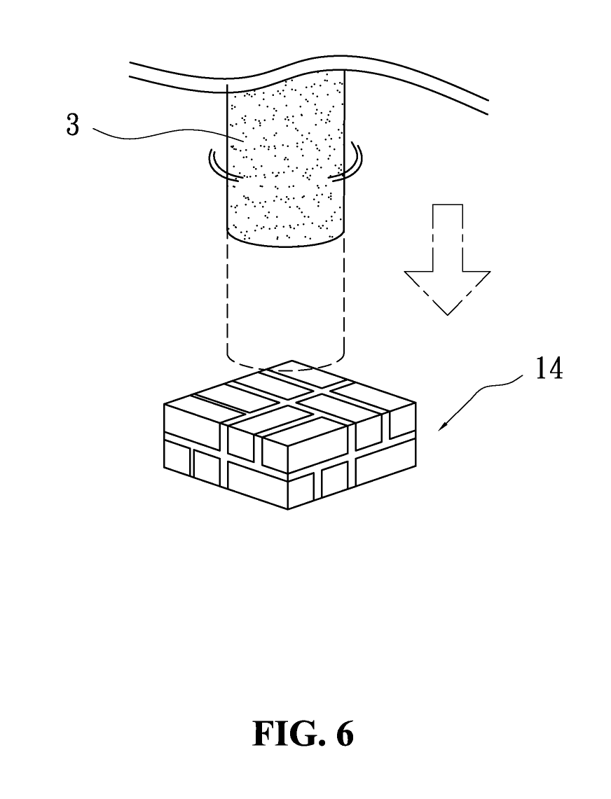

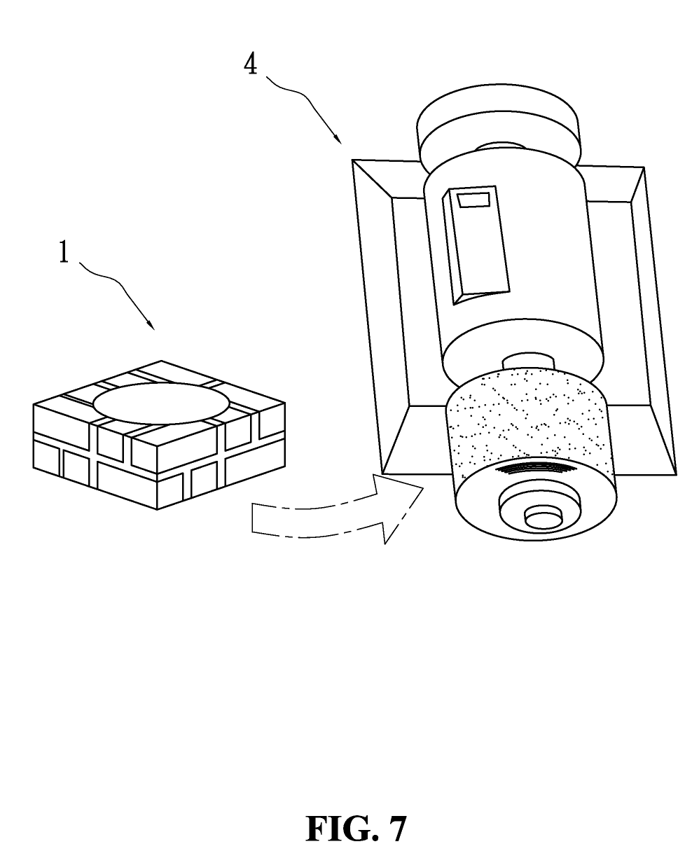

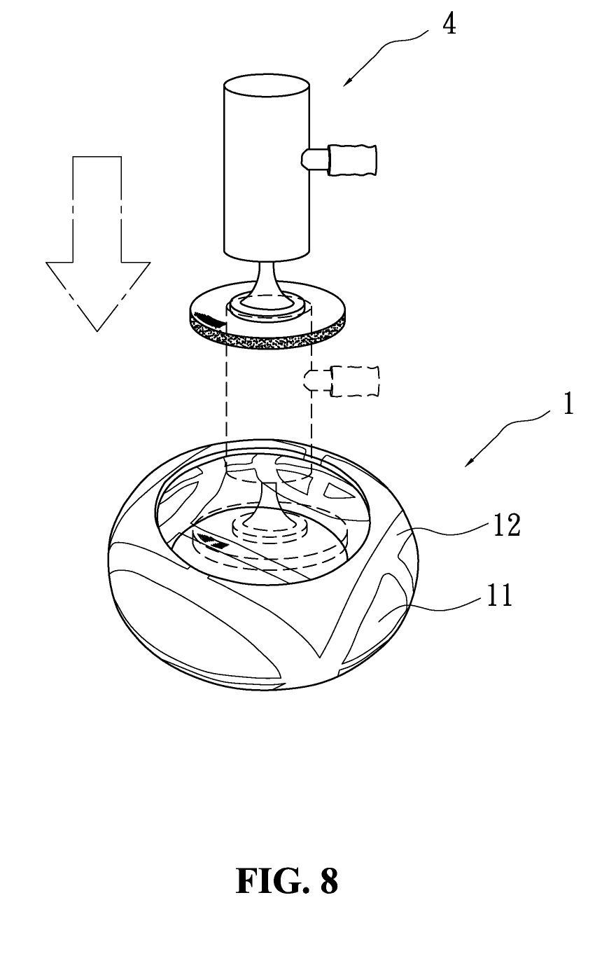

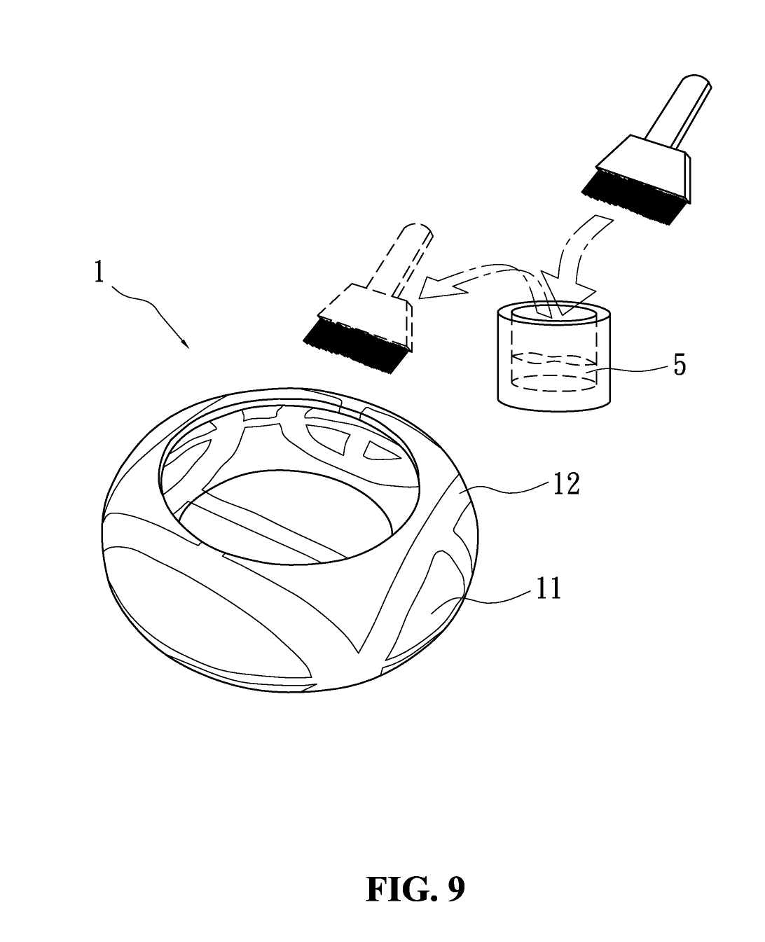

With reference to FIGS. 3 to 9, it is noted from the series of drawings that the method adopted by the present invention includes the steps of preparing an adhesive agent (A), forming a durable base by applying the adhesive agent to adjacent bricks (B), cutting the durable base into a desired shape (C), and polishing the cut base (D).

In the step of adhesive agent preparation, the silica sand, cement and polymer clay benefits, each combined with one another with an appropriate proportion, e.g. 1:1:1 to form the adhesive agent as required by the method of the present invention.

In the step of forming a durable base, multiple fair bricks 11 are stacked on top of one another with the adhesive agent of the present invention applied to the outer surfaces of each of the fair bricks 11 so that the multiple fair bricks 11 are able to be combined together securely to form the durable base 13.

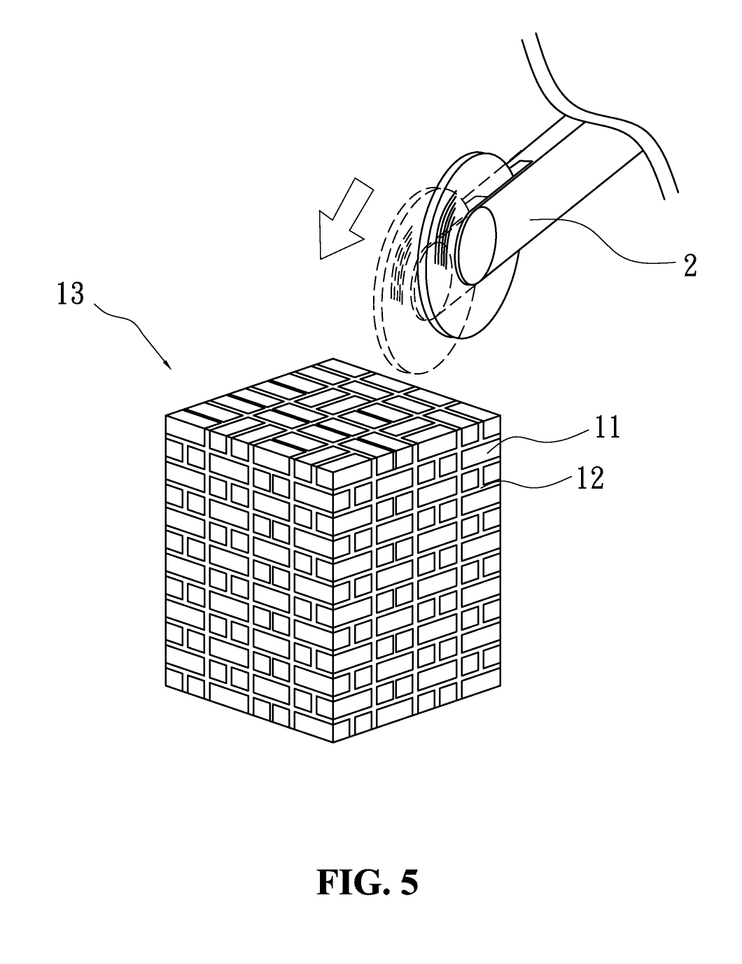

In the step of cutting the durable base 13, the durable base 13 is initially cut into a desired shape via a cutting machine 2. In practice, the cutting machine 2 is used to cut the durable base 13 (as shown in FIG. 5). Then, the initially cut semi-finished product 14 of the present invention is brought to another station for another fabrication process.

In the last step of polishing the initially cut semi-finished product 14, a polishing machine 4 is employed to finely polish the outer surface of the semi-finished product 14 and a puncher 3 is also employed to process a blind hole in the product 14. It is noted that the blind hole may be located anywhere in the product 14 to fit different requirements. In addition, a waterproof coating 5, preferably epoxy, may be applied to the finished product to increase the waterproof capability of the product.

A drying process may be added to the method of the present invention. That is, after the semi-finished product 14 is polished, the polished semi-finished product is sent to an environment where the temperature is kept constant so that the product is able to undergo a drying process for eight (8) hours, for example. Still further, a secondary cutting process may be employed to fine tune the shape of the product.

From the disclosure of the present invention, it is notable that the brick product constructed in accordance with the present invention is a breakthrough of a conventional structure and expand the application possibility of conventional brick structure.

Those skilled in the art will readily observe that numerous modifications and alterations of the device and method may be made while retaining the teachings of the invention.

What is claimed is:

1. A brick product comprising:
multiple brick segments respectively bonded to one another via an adhesive agent; and
a blind hole defined in a body of the respectively bonded brick segments.

2. The brick product as claimed in claim 1, wherein the adhesive agent is composed of silica sand, cement and polymer clay benefits.

3. The brick product as claimed in claim 2, wherein the silica sand, cement and polymer clay benefits are mixed with one another at a ratio of 1:1:1.

4. The brick product as claimed in claim 1 further comprising a waterproof coating on outside surfaces of the multiple brick segments.

5. A method for fabricating a brick product comprising the steps of:
preparing an adhesive agent;
forming a durable base by applying the adhesive agent to adjacent bricks;
cutting the durable base into a desired shape; and
polishing the cut base.

6. The method as claimed in claim 5, wherein the adjacent bricks are stacked on top of one another alternatively.

7. The method as claimed in claim 5, wherein a secondary cut step is introduced to fine tune the shape of the durable base.

8. The method as claimed in claim 5 further comprising a waterproof coating applying step after the cut base polishing step.

9. The method as claimed in claim 5 further comprising a drying process to dry out water content in the polished and cut base.

10. The method as claimed in claim 7 further comprising a waterproof coating applying step after the cut base polishing step.

11. The method as claimed in claim 7 further comprising a drying process to dry out water content in the polished and cut base.

12. The method as claimed in claim 8 further comprising a drying process to dry out water content in the polished and cut base.
